(19) United States
(12) Patent Application Publication
(10) Pub. No.: US 2024/0151012 A1
(43) Pub. Date: May 9, 2024

(54) SANITARY UNIT COMPRISING A PRESSURE-REDUCING VALVE

(71) Applicant: Neoperl GmbH, Müllheim (DE)

(72) Inventors: Werner KURY, Müllheim (DE); Martin FANGMEIER, Auggen (DE)

(73) Assignee: Neoperl GmbH, Müllheim (DE)

(21) Appl. No.: 18/282,052

(22) PCT Filed: Mar. 16, 2022
(86) PCT No.: PCT/EP2022/056784

§ 371 Date: Sep. 14, 2023

(30) Foreign Application Priority Data
Mar. 17, 2021 (DE) 202021101345.1

(51) Int. Cl. E03C 1/02; G05D 16/10

(52) U.S. Cl. CPC E03C 1/021; G05D 16/103; E03C 2001/026

(57) ABSTRACT

The invention relates to a sanitary unit (1) comprising a pressure-reducing valve (2) that has a valve housing (3) containing a valve support (6) provided with at least one through-flow channel (7), said valve comprising a cup-shaped valve body (5) which is guided such that it moves from an open position against a restoring force into a closed position. In the closed position, the valve body (5) sits on a valve seat (11) provided on the valve support (6) with the circumferential edge (9) of its cup shape, in such a way that the valve body (5) blocks at least one channel opening (12) of the at least one through-flow channel (7). The sanitary unit according to the invention 54 is characterised, inter alia, in that the valve housing (3) has an external or internal thread (22) for screw connection to a coupling counterpart (23).

### FIELD OF THE INVENTION

The invention relates to a sanitary unit comprising a pressure-reducing valve which has a valve housing, in the housing interior of which a valve support which has at least one throughflow channel is provided, and which valve housing has a cup-shaped valve body which is guided displaceably from an open position counter to a restoring force into a closed position, in which closed position the valve body lies with the circumferential edge of its cup shape on a valve seat, which is provided on the valve support, in such a manner that the valve body closes at least one channel opening of the at least one throughflow channel.

### SUMMARY

It is in particular the object to provide a sanitary unit of the type mentioned at the beginning which is distinguished by as simple handling as possible and with which the risk of leakages in an outflow-side section of the sanitary installation can be at least reduced.

This object is achieved according to the invention, in the case of the sanitary unit of the type mentioned at the beginning, in particular in that the valve housing has an internal or external thread for the screw connection to a coupling counterpart.

The sanitary unit according to the invention has a pressure-reducing valve with a valve housing which has an internal or external thread for the screw connection to a coupling counterpart. Since the valve housing of the pressure-reducing valve according to the invention is therefore part of a line coupling, and since the valve support of a pressure-reducing valve is inserted in the housing interior of the valve housing, the risk of a leakage in the region of the line coupling and of the line section following the line coupling in the flow direction is reduced. Since, in the case of the sanitary unit according to the invention, the pressure-reducing valve is inserted into the line coupling, it is avoided that the pressure-reducing valve is unintentionally not installed at the same time. The sanitary unit according to the invention is therefore also distinguished by simple handling in the installation and/or subsequent operation.

A preferred development according to the invention makes provision that the valve housing is designed as a sleeve-shaped receiving adapter of a line coupling. Since the valve housing is designed as a sleeve-shaped receiving adapter of a line coupling and makes an additional adapter with a pressure-reducing valve unnecessary, the risk of a leakage in the region of such an adapter, on the one hand, and in the line connection of the following line section, on the other hand, is reduced and a short overall length of the sanitary unit according to the invention in the region of its pressure-reducing valve is also additionally supported. Since the valve housing is designed as a sleeve-shaped receiving adapter of the line coupling, it is avoided that the pressure-reducing valve is unintentionally not installed at the same time.

A preferred embodiment according to the invention here makes provision that the valve housing is configured as a hose sleeve nut of a line coupling designed as a hose coupling.

In order to be able to connect this hose line securely and tightly to the valve housing, designed as a hose sleeve nut, of the unit according to the invention, it is advantageous if a preferably profiled hose nipple for the pushing-on of a hose end region of a flexible hose line is provided on a second end face region of the valve housing designed as a hose sleeve nut.

A particularly simple and easily producible embodiment according to the invention makes provision that the valve housing and the hose nipple are connected integrally to each other.

The simple handling of the unit according to the invention even during its installation and removal is additionally also supported if the valve housing and the hose nipple are connected rotatably and liquid-tightly to each other. In this way, the screw connection provided between the hose connection and the inflow-side coupling counterpart can easily be handled without undesirable connections and connections stressing the elastic material of the flexible hose line having to be of concern.

A particularly simple and easily producible exemplary embodiment according to the invention makes provision that the valve housing has, at its second end face region, a through-passage opening into which the hose nipple can be inserted until an annular shoulder or annular flange protruding on the hose nipple lies on the housing edge of the valve housing surrounding the through-passage opening.

If the hose nipple is designed so as to be rotatable relative to the valve housing designed as a hose sleeve nut, it is advantageous if the annular zone between the hose nipple and the housing edge surrounding the through-passage opening is sealed by means of at least one annular seal.

The installation of the unit according to the invention is additionally also simplified if the hose nipple circumferentially has a receiving groove protruding into the through-passage opening, in which receiving groove the annular seal is held.

Possible leakages in the region of the hose coupling are additionally also counteracted if the hose end region, which is pushed onto the hose nipple, of the flexible hose line is held and secured on the hose nipple by means of a pinch or crimp sleeve.

A further proposal for achieving the above-described object, for which protection is independently claimed here, makes provision that the pressure-reducing valve is connected upstream of at least one line section, which line section has at least one control and/or shut-off valve and, additionally or instead, at least one cross-sectional constriction in the clear line cross section. Since the line section connected downstream of the pressure-reducing valve has at least one control and/or shut-off valve and/or has at least one cross-sectional constriction in the clear cross section, the fluid building up upstream of said flow obstruction can reach high-pressure peaks which could ultimately lead to bursting and therefore to leakage of the line section connected upstream of the flow obstruction. Since, however, the pressure-reducing valve which is integrated in the line section and in particular in a line coupling there adjusts the pressure prevailing in the line section between the pressure-reducing valve and the control and/or closing valve or the cross-sectional constriction to a defined maximum pressure, bursting of said line section and a corresponding leakage are effectively avoided. Since, by means of the pressure-reducing valve, the pressure ratios prevailing in the line section can be limited to a defined maximum value, the line section and the sanitary installations and water outlets connected to said line section, even with comparatively small wall thicknesses, can nevertheless be configured to be sufficiently stable, and therefore reduced production costs for the line sections following the pressure-reducing valve can also be achieved.

The advantages which can be achieved with the above-described invention proposal are not only limited to the at least one line section following the pressure-reducing valve; on the contrary, these advantages can also be achieved if the line section connected downstream of the pressure-reducing valve is connected to at least one sanitary installation and/or to at least one water outlet.

Since a line section is exposed in particular to particularly high-pressure peaks whenever the flow through said line section is limited or has even stopped, an advantageous embodiment according to the invention makes provision that the at least one sanitary installation or the at least one sanitary water outlet has the cross-sectional constriction or the control and/or closing valve.

A particularly advantageous development according to the invention makes provision that the pressure-reducing valve is connected upstream of a first hose end of the line section configured as a flexible hose line, which hose line is connected at its second hose end to a hygiene shower or similar shower head serving as a water outlet, which shower head has a control and/or shut-off valve.

In particular, such hygiene showers are regularly deposited in their stand-by position outside the toilet seat and also outside another item of sanitaryware. If a particularly excessive water pressure stresses the flexible hose line leading to the hygiene shower, there is the risk that the elastic material of the flexible hose line will burst and the water coming from the water supply line may flow out unobstructed and pour onto the floor next to the toilet seat. Since the pressure-reducing valve of the sanitary unit according to the invention is connected upstream of a first hose end of a flexible hose line in the throughflow direction, which hose line is connected at its second hose end to the hygiene shower or similar shower head, a control and/or shut-off valve connected upstream of the hose line on the inflow side can be dispensed with. Since, instead, the control and/or shut-off valve is integrated in the hygiene shower or similar shower head of the sanitary unit according to the invention, this shower head of the sanitary unit according to the invention can also be comfortably operated and adjusted single-handedly. Since the pressure-reducing valve is connected upstream of the flexible hose line, an undesirable bursting of the hose line and therefore an uncontrolled discharge of water is counteracted.

The pressure-reducing valve provided according to this invention proposal can have a valve housing which is designed as a separate adapter which is connected upstream of the inflow-side hose connection of a following flexible hose line. However, an embodiment is also preferred here in which the pressure-reducing valve of the sanitary unit according to the invention has a valve housing designed as a hose sleeve nut.

The installation of the sanitary unit according to the invention is additionally also facilitated if the valve support of the pressure-reducing valve is designed as an insert cartridge which can be inserted into a sleeve opening arranged on the first end face region of the valve housing.

The present invention also relates to the use of a sanitary unit with a pressure-reducing valve. To achieve the above object, the use according to the invention of the sanitary unit makes provision that the pressure-reducing valve is connected to a sanitary installation which preferably directly follows it in the flow direction and/or to at least one water outlet, which sanitary installation and/or which at least one sanitary water outlet has at least one cross-sectional constriction in the clear line cross section, or at least one control and/or shut-off valve.

### BRIEF DESCRIPTION OF THE DRAWINGS

Developments according to the invention emerge from the description below of preferred exemplary embodiments in conjunction with the claims and the drawing. The invention will also be described in more detail below with reference to preferred exemplary embodiments.

In the drawings:

FIG. 1 shows a sanitary unit, here sectioned longitudinally, with a pressure-reducing valve, the valve housing of which is designed as a sleeve-shaped hose sleeve nut, which hose sleeve nut has, on a first end face region on the inner circumferential side, an internal thread for the screw connection to a coupling counterpart and has, on its second end face region, a profiled hose nipple for the pushing-on of a hose end region of a flexible hose line,

FIG. 2 shows the sanitary unit from FIG. 1 in a partial longitudinal section, wherein only the valve housing designed as a hose sleeve nut is cut open, while the pressure-reducing valve which is located in the housing interior has not been cut open further here,

FIG. 3 shows a sanitary unit designed comparably to FIGS. 1 and 2 in a longitudinal section, wherein this unit here has a pressure-reducing valve with a valve housing, on which valve housing the hose nipple is held rotatably and simultaneously liquid-tightly,

FIG. 4 shows a use example of the sanitary units shown in FIGS. 1 to 3 and 5, in which exemplary embodiment the pressure-reducing valve of the sanitary units marked here by a circle is connected upstream of a first hose end of a flexible hose line in the throughflow direction, which hose line is connected at its second hose end to a hygiene shower or identical shower head in which a control and/or shut-off valve is integrated,

FIG. 5 shows a sanitary unit with a pressure-reducing valve, the valve housing of which is designed here as an adapter and which is screwed onto the inflow-side hose connection of a hose line, which hose line leads to a hygiene shower or similar shower head with integrated control and/or shut-off valve,

FIG. 6 shows a sanitary supply line with a sanitary unit which likewise has a pressure-reducing valve here and with a line section connected downstream of it in the flow direction, wherein an outflow-side control and/or closing valve is integrated in the line section, and an instantaneous water heater, a boiler or similar sanitary installation is connected in between,

FIG. 7 shows a sanitary supply line in the region of a sanitary installation of the abovementioned type, which is also indicated here merely by way of example in the shape of a box, which sanitary installation is connected at its inflow, which is designed as a nozzle-shaped coupling counterpart, to the valve housing of a pressure-reducing valve, which valve housing is designed as a sleeve-shaped receiving adapter and has an internal thread or, as here, an external thread for the screw connection to the coupling counterpart, wherein the sanitary installation has, downstream of its inlet in the flow direction, at least one cross-sectional constriction in the clear line cross section or at least one control and/or shut-off valve which, likewise as here, can also be provided in the region of the outlet of the sanitary installation, and

FIG. 8 shows an exemplary embodiment configured comparably to FIG. 7, wherein the inlet of the sanitary installation here is, however, designed directly as the valve housing, in the housing interior of which the valve support of a pressure-reducing valve can be inserted.

### DETAILED DESCRIPTION OF THE PREFERRED EMBODIMENTS

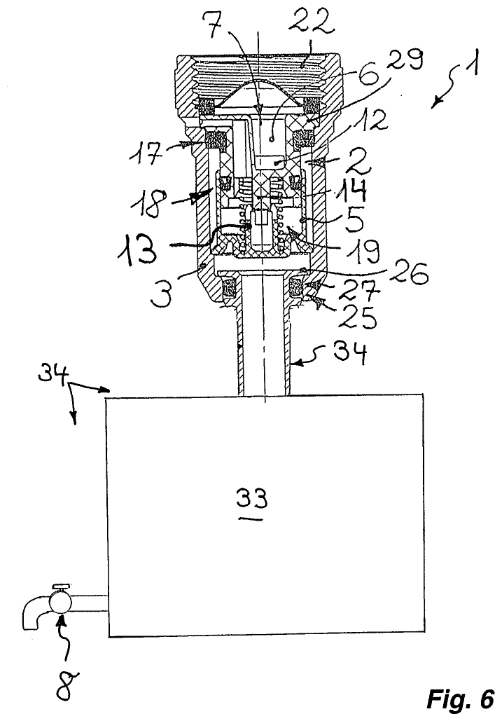

FIGS. 6 to 8 illustrate a sanitary water line which has an outflow-side control and/or shut-off valve 8 or similar cross-sectional constriction in the clear throughflow cross section and in which a sanitary unit 1, 10, 100, which is also described in more detail below, with a pressure-reducing valve 2 is connected in between. Between the pressure-reducing valve 2 and the outlet-side control and/or shut-off valve 8, it is also possible to connect a sanitary installation 33 which can be designed, for example, as an instantaneous water heater, as a water reservoir or the like. Since the line section 34 connected downstream of the pressure-reducing valve 2 has at least the one control and/or shut-off valve 8 and/or at least one cross-sectional constriction in the clear line cross section, the water building up upstream of said flow obstruction can reach high-pressure peaks which could ultimately lead to splitting or bursting and therefore to leakage of the line section 34 connected upstream of the pressure obstruction. Since, however, the pressure-reducing valve 2 which is integrated in the line according to FIGS. 6 to 8 and in particular in a line coupling there adjusts the water pressure prevailing in the line section between the pressure-reducing valve 2 and the outflow-side control and/or shut-off valve 8 or similar cross-sectional constriction to a defined maximum pressure, bursting of the line section 34 and a corresponding leakage are effectively avoided. Since, by means of the pressure-reducing valve 2, the pressure ratios prevailing in the line section 34 can be limited to a defined maximum value, the line section 34 and the sanitary installation 33 which is connected to the line section 34 can also be configured to be comparatively thin-walled and nevertheless sufficiently stable, and therefore lower production costs for the line sections 34 following the pressure-reducing valve 2 can also be achieved.

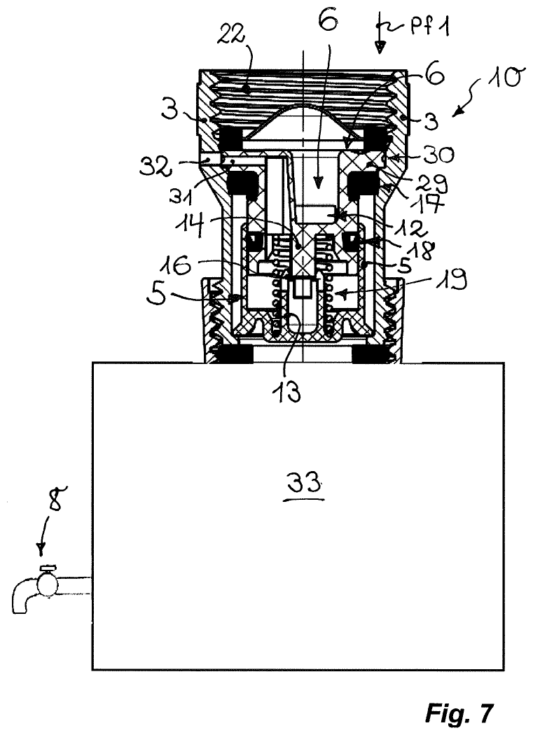

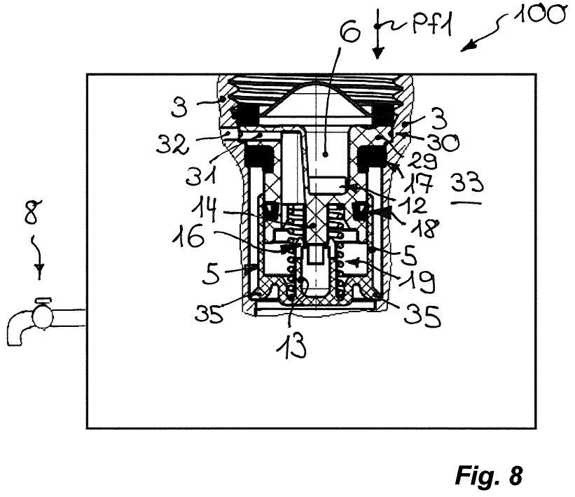

While said optionally also thin-walled line sections 34 in the exemplary embodiments according to FIGS. 7 and 8 are provided in the interior of the sanitary installation 33, indicated here in the shape of a box, a partial region of the line section 34 following the pressure-reducing valve 2 is shown outside the sanitary installation 33, only illustrated schematically here, in the exemplary embodiment shown in FIG. 6.

In the exemplary embodiment illustrated in FIG. 6, it is shown that the sanitary unit 1 having the pressure-reducing valve 2 is connected to the sanitary installation 33 following it in the flow direction via the line section 34 which does not necessarily have to be a flexible hose line here, but can also be designed as a pipe produced from plastic, metal or another suitable material. Since the sanitary unit 1 with the pressure-reducing valve 2 is connected upstream of the line section 34, and since the pressure-reducing valve 2 reduces and adjusts the water pressure present in the line section 34 following on the outflow side to a defined maximum value, the wall thicknesses in the line section 34 and/or in the sanitary installation 33 connected in between can be reduced in accordance with the defined maximum value of the water pressure and nevertheless can be configured to be sufficiently stable such that bursting of the water line and a corresponding leakage are avoided. In addition to or instead of the outflow-side control and/or shut-off valve 8, a cross-sectional constriction can also be provided in particular in the sanitary installation 33, which cross-sectional constriction would, without the pressure-reducing valve 2, otherwise lead to undesirably high-pressure peaks in the line section connected upstream in the flow direction.

The further details of the sanitary unit 1, 10, 100 having a pressure-reducing valve 2 will also be described in more detail with reference to the following exemplary embodiments.

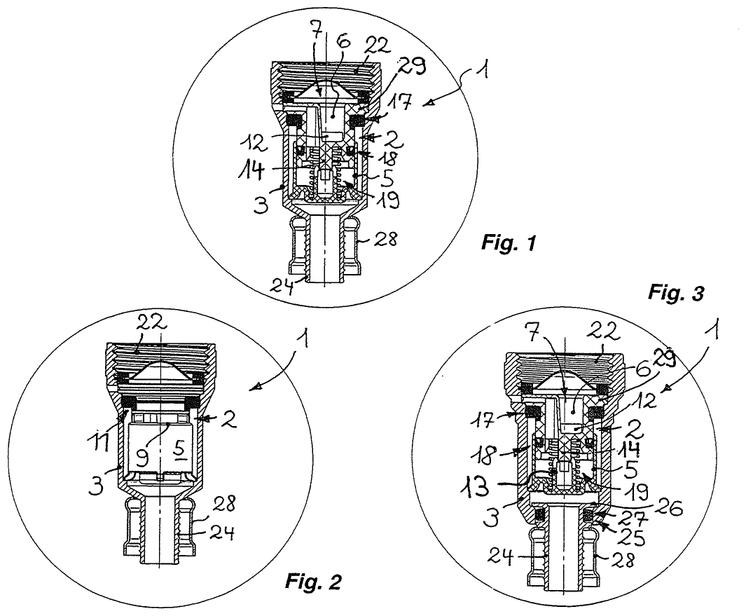

FIGS. 1 to 8 illustrate various embodiments 1, 10, 100 of a sanitary unit which has a pressure-reducing valve 2 with a valve housing 3. The pressure-reducing valve 2 through which the flow passes in the arrow direction Pf 1 can be, for example, inserted into a water line in order to limit the water pressure in the line section situated downstream of the pressure-reducing valve 2 to a defined maximum value. The valve housing 3 of the pressure-reducing valve 2 has a cup-shaped valve body 5 in its housing interior. The pressure-reducing valve 2 of the sanitary units 1, 10, 100 has a valve support 6 in which at least one throughflow channel 7 is provided. If the line cross section is constricted in the region of the following line section, for example because the control and/or shut-off valve 8 provided on the outflow side is only opened slightly, and the water pressure rises increasingly there, the displaceably guided valve body 5 is moved under the pressure of the through flowing medium from the open position shown in FIGS. 1, 3, 5, 7 and 8 counter to the restoring force of at least one restoring element into a closed position, in which closed position the valve body 5 lies with the circumferential edge 9 of its cup shape on a valve seat 11, which is provided on the valve support 6, in such a manner that the valve body 5 closes at least a channel opening 12 of the at least one throughflow channel 7. Since, as the water pressure rises, the valve body 5 is increasingly pressed in the line section, which is placed upstream of the pressure-reducing valve 2, against the restoring force of the at least one restoring element in the direction of the valve support 6 and therefore the pressure loss at the channel opening 12, which therefore is becoming smaller, increases, the pressure of the fluid in the line section placed downstream of the pressure-reducing valve 2 is limited to a defined maximum value.

It can be seen in FIGS. 1, 3 and 5 to 8 that a central holding sleeve 13 into which a holding pin 14 arranged on the valve support 5 protrudes is provided on the inside of the cup base of the valve body 5. A stop 15 is provided on the inner circumference of the holding sleeve 13, the stop interacting with a mating stop 16 on the outer circumference of the holding pin 14 in such a manner that, in the open position of the pressure-reducing valve 2, the stop 15 and the mating stop 16 limit the sliding path of the valve body 5 relative to the valve support 6. Since the stop 15 and the mating stop 16 interacting therewith limit the sliding path of the valve body 5 relative to the valve support 4 into the opening position, an unintentional dropping out of the pressure-reducing valve 2 illustrated here during storage, during transport or during the installation is counteracted. Valve support 6, valve body 5 and the restoring element effective between them, together with the associated annular seals 17, 18, virtually form an insert unit which merely has to be inserted into the valve housing 3 to complete the pressure-reducing valve 2. This substantially simplifies the installation of the pressure-reducing valve 2 illustrated here.

It can be seen in FIGS. 1, 3 and 5 to 8 that the at least one restoring element is designed here as a helical compression spring 19. The helical compression spring 19, which serves as the restoring element, engages here around the holding pin 14 and the holding sleeve 13. The holding pin 14 and the holding sleeve 13 are oriented coaxially with respect to each other and with respect to the longitudinal axis of the valve housing.

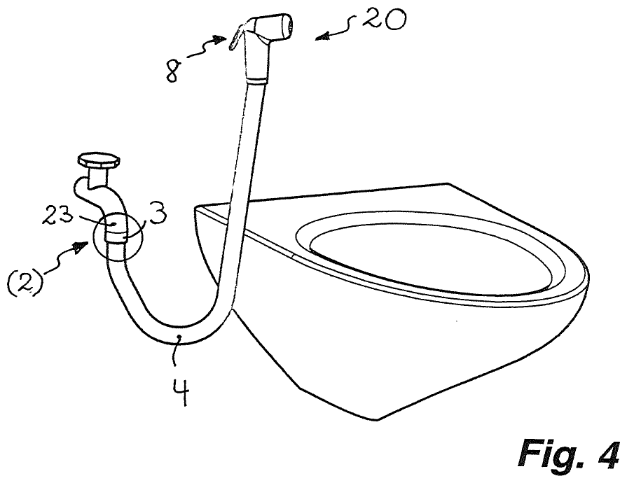

It is illustrated in FIG. 4 that the pressure-reducing valve 2 of the sanitary units 1, 10, 100 shown here can be connected upstream in the throughflow direction of a first hose end of a flexible hose line 4, which hose line 4 is connected at its second hose end, for example, to a hygiene shower 20 or similar shower head in which the control and/or shut-off valve 8 is integrated.

The valve housing 3 of the pressure-reducing valve 2 connected upstream of the hose line 4 can be designed here as a separate screw adapter, which screw adapter has an internal thread 22 on the inflow-side end face region of the valve housing 3 and an external thread 33 on its opposite second end face region, with which external thread 33 the valve housing 3 of the sanitary unit 10 can be screwed into the hose sleeve nut fitting 21 of the hose line 4 following on the outflow side.

In the case of the sanitary unit 1 shown in FIGS. 1 to 3, the valve housing 3 itself is designed as a sleeve-shaped hose sleeve nut of a hose coupling, which hose sleeve nut has, on an inner circumferential side on a first end face region, an internal thread 22 for the screw connection to a coupling counterpart 23. As FIGS. 1 to 3 show, a preferably profiled hose nipple 24 is provided on the second end face region of the valve housing 3 designed as a hose sleeve nut, the hose nipple being provided for the pushing-on of a hose end region of the flexible hose line 4.

While, in the case of the exemplary embodiment of the sanitary unit 1 that is shown in FIGS. 1 and 2, the valve housing 3 and the hose nipple 24 are connected integrally to each other, in the case of the sanitary unit 1 shown in FIG. 3 the valve housing 3 and the hose nipple 24 are connected rotatably and liquid-tightly to each other. In the case of the exemplary embodiment shown in FIG. 3, the valve housing 3 has, on its second end face region, a through-passage opening 25 into which the hose nipple 24 can be inserted until an annular shoulder or annular flange 26 protruding on the hose nipple 24 lies on the housing edge of the valve housing 3 surrounding the through-passage opening 25. In this case, the annular zone between the hose nipple 24 and the housing edge surrounding the through-passage opening 25 is sealed by means of at least one annular seal 27 which is held in a receiving groove protruding into the through-passage opening 25.

It becomes clear from a comparison of FIGS. 1 to 3 and 5 to 8 that the valve support 6 of the pressure-reducing valve 2 is designed here as an insert cartridge which can be inserted into an insertion opening arranged on the first end face region of the valve housing 3.

It becomes clear from FIGS. 1 to 3 and 5 to 8 that the valve support 6 has a valve support section 29, which valve support section 29 lies on the housing inner circumference of the valve housing 3 and which, in the use position of the pressure-reducing valve 2, is held immovably in the housing interior of the valve housing 3. Said valve support section 29 is substantially plate-like. So that the fluid flowing through the pressure-reducing valve can pass only through the at least one throughflow channel 7, the valve support section 29 is provided with the annular seal 17 which also forms the valve seat 11 here and with which said valve support section 29 lies tightly on the housing inner circumference of the valve housing 3. On the plate-like valve support section 29 protrudes a pin-shaped guide section of the valve support 6, on which guide section the valve body 5 is displaceably guided with its valve body inner circumference. Said guide section of the valve support 6 has the holding sleeve 13 on its end face directed toward the valve body interior. Also arranged on the guide section of the valve support 4 is the annular seal 18 which seals the cup interior of the cup-shaped valve body in relation to the fluid flowing through it. In this case, the annular seal 18 lies tightly on the cup inner circumference of the valve body 5. At least one sliding element 35 and preferably more than two sliding elements 35 which are spaced apart in particular uniformly from one another in the circumferential direction are provided on the valve body 5, the sliding elements protruding in the radial direction over the valve body 5 in such a manner that an annular channel is formed between the housing inner circumference of the valve housing 3, on the one hand, and the outer circumference of the valve body 5, on the other hand. Since the valve body 5 slides only with its laterally protruding sliding elements 34 on the housing inner circumference of the valve housing 3, the friction surface of the valve body 5 is effectively reduced.

It becomes clear from FIGS. 1 to 3 and 5 to 8 that an annular groove 30 is provided on the outer circumference of the valve support section 29. Said annular groove 30 is connected via at least one ventilation channel 31 to the cup interior of the cup-shaped valve body 5. At least one ventilation opening 32 which opens into the annular groove 30 on the valve support section 29 is provided in the valve housing 3 of the pressure-reducing valve 2. During the sliding movements of the valve body 5, the air trapped in the cup interior of the cup-shaped valve body 5 can escape via the ventilation channel 31 and the ventilation opening 32. This prevents an undesirable counterpressure from being able to build up in the cup interior of the cup-shaped valve body 5 when the pressure of the outlet-side fluid presses the valve body 5 onto the pin-shaped guide section of the valve support 6. With the aid of the pressure-reducing valve 2 located in the valve housing 3, the hose line 4 following on the outflow side can be protected against an excessive pressure of the fluid and against pressure-induced bursting.

It is shown in FIGS. 1 to 8 that at least one line section can be connected downstream of the pressure-reducing valve 2 in the throughflow direction Pf 1, which line section has at least one control and/or shut-off valve 8 or at least one cross-sectional constriction in the clear line cross section. As is shown in FIGS. 6 to 8, the line section 34 connected downstream of the pressure-reducing valve 2 can be connected to at least one water outlet and/or to at least one sanitary installation 33. It is illustrated schematically in FIGS. 6 to 8 that the at least one sanitary installation 33 has the cross-sectional constriction or, as here, the control and/or shut-off valve 8.

In FIGS. 1 to 3, the valve housing 3 of the sanitary units 1 is configured as a hose sleeve nut of a line section which follows in the flow direction and is designed as a flexible hose line 4. In the case of the exemplary embodiments 1, 10, 100 shown in FIGS. 6 to 8, the valve housing 3 is connected to the inlet of a sanitary installation following it in the flow direction Pf 1 (cf. FIGS. 6 and 7) or is integrated in the inlet of said sanitary installation 33 (cf. FIG. 8). The valve support 6 which has the throughflow channel 7 is inserted in the housing interior of the valve housing 3. The cup-shaped valve body 5 is guided displaceably on the valve support 6 from an open position counter to a restoring force into a closed position, in which closed position the valve body 5 lies with the circumferential edge 9 of its cup shape on a valve seat 11, which is provided on the valve support 6, in such a manner that the valve body 5 closes at least one channel opening 12 of the at least one throughflow channel 7. In the case of the exemplary embodiments shown in FIGS. 6 to 8, the valve housing 3 which is connected to the inlet of the sanitary installation 33 or is integrated in the inlet also has an external thread or internal thread 22 for the screw connection to a coupling counterpart which is not shown specifically here and which is arranged on the inflow side, which coupling counterpart connects the sanitary installation 33 via the valve housing 3 and the pressure-reducing valve 2 thereof to a line section connected upstream in the flow direction Pf 1. The pressure-reducing valve 2 is, for its part, connected upstream of at least one line section in the throughflow direction Pf 1, which line section has at least one control or shut-off valve 8 or at least one cross-sectional constriction in the clear cross section. Said line section 34 which is connected downstream of the pressure-reducing valve 2 is connected to the at least one sanitary installation 33 and to the water outlet provided at the outlet thereof. In the exemplary embodiments according to FIGS. 6 to 8, the sanitary installation 33 and its water outlet have the cross-sectional constriction or the control or shut-off valve 8.

### LIST OF REFERENCE SIGNS

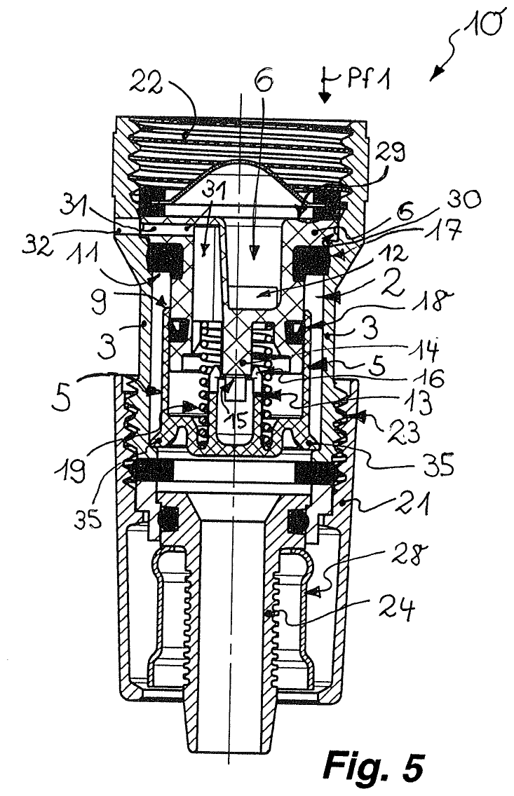

1 Sanitary unit (according to FIGS. 1 to 3 and 6)
2 Pressure-reducing valve
3 Valve housing
4 Hose line
5 Valve body
6 Valve support
7 Throughflow channel
8 Control and/or shut-off valve
9 Circumferential edge
10 Sanitary unit (according to FIGS. 5 and 7)
11 Valve seat
12 Channel opening
13 Holding sleeve
14 Holding pin
15 Stop
16 Mating stop
17 Annular seal
18 Annular seal
19 Helical compression spring
20 Hygiene shower
21 Hose sleeve nut fitting (of the sanitary unit according to FIG. 5)
22 Internal thread
23 Coupling counterpart
24 Hose nipple
25 Through-passage opening
26 Annular flange
27 Annular seal
28 Pinch or crimp sleeve
29 Valve support section
30 Annular groove
31 Ventilation channel
32 Ventilation opening
33 Sanitary installation
34 Line section
35 Sliding element
100 Sanitary unit (according to FIG. 8)
Pf 1 Throughflow direction

1. A sanitary unit comprising a pressure-reducing valve (2) which has a valve housing (3), having a first end face region, in the housing interior of which a valve support (6) which has at least one throughflow channel (7) is provided, said valve housing comprising a cup-shaped valve body (5) which is guided displaceably from an open position counter to a restoring force into a closed position, in said closed position the valve body (5) lies with a circumferential edge (9) of its cup shape on a valve seat (11), which is provided on the valve support (6), in such a manner that the valve body (5) closes at least one channel opening (12) of the at least one throughflow channel (7), wherein the valve housing (3) has an external or internal thread (22) for a screw connection to a coupling counterpart (23).

2. The sanitary unit as claimed in claim 1, wherein the valve housing (3) is configured as a sleeve-shaped receiving adapter of a line coupling.

3. The sanitary unit as claimed in claim 1, wherein the valve housing (3) is configured as a hose sleeve nut of a line coupling designed as a hose coupling.

4. The sanitary unit as claimed in claim 3, wherein a profiled hose nipple (24) for pushing-on of a hose end region of a flexible hose line (4) is provided on a second end face region of the valve housing (3) configured as a hose sleeve nut.

5. The sanitary unit as claimed in claim 4, wherein the valve housing (3) and the hose nipple (24) are connected integrally to each other.

6. The sanitary unit as claimed in claim 4, wherein the valve housing (3) and the hose nipple (24) are connected rotatably and liquid-tightly to each other.

7. The sanitary unit as claimed in claim 6, wherein the valve housing (3) has, at its second end face region, a through-passage opening (25) into which the hose nipple (24) is insertable up to an annular shoulder or annular flange (26) protruding on the hose nipple (24) lies on a housing edge of the valve housing (3) surrounding the through-passage opening (25).

8. The sanitary unit as claimed in claim 7, wherein the annular zone between the hose nipple (24) and the housing edge surrounding the through-passage opening (25) is sealed by means of at least one annular seal (17).

9. The sanitary unit as claimed in claim 8, wherein the hose nipple (24) circumferentially has a receiving groove protruding into the through-passage opening (25), in which receiving groove the at least one annular seal (27) is held.

10. The sanitary unit as claimed in claim 4, wherein the hose end region pushed onto the hose nipple (24) is held on the hose nipple (24) by means of a pinch or crimp sleeve (28).

11. The sanitary unit as claimed in claim 1, wherein the pressure-reducing valve (2) is connected upstream of at least one line section (34) in the throughflow direction (Pf1), which line section (34) has at least one control and/or shut-off valve (8) or at least one cross-sectional constriction in the clear line cross section.

12. The sanitary unit as claimed in claim 11, wherein the line section (34) connected downstream of the pressure-reducing valve (2) is connected to at least one of: at least one sanitary installation (33) or to at least one water outlet.

13. The sanitary unit as claimed in claim 12, wherein the at least one sanitary installation (33) or the at least one sanitary water outlet has a cross-sectional constriction or at least one of: a control or a shut-off valve (8).

14. The sanitary unit as claimed in claim 13, wherein the pressure-reducing valve is connected upstream of a first hose end of the line section configured as a flexible hose line (4), said hose line (4) is connected at a second hose end thereof to a hygiene shower (20) head, said shower head comprising at least one of the control or shut-off valve (8).

15. The sanitary unit as claimed in claim 1, wherein the valve support (6) of the pressure-reducing valve (2) is configured as an insert cartridge which is insertable into a sleeve opening arranged on the first end face region of the valve housing (3).

16. The sanitary unit as claimed in claim 1, wherein the valve support (6) has a valve support section (29), said valve support section (29) lies securely on an inner circumference of the valve housing (3).

17. The sanitary unit as claimed in claim 16, wherein the valve support section (29) of the valve support (6) is plate-like.

18. The use of a sanitary unit comprising a pressure-reducing valve (2) according claim 1, wherein the pressure-reducing valve (2) is connected to a sanitary installation (33) which directly follows the pressure-reducing valve (2) in at least one of: a flow direction (Pf 1) or to at least one water outlet, said sanitary installation or said at least one sanitary water outlet has at least one cross-sectional constriction in the clear line cross section, or at least one of: a control or shut-off valve (8).
